(19) United States
(12) Patent Application Publication
(10) Pub. No.: US 2022/0128690 A1
(43) Pub. Date: Apr. 28, 2022

(54) LIGHT RECEIVING DEVICE, HISTOGRAM GENERATING METHOD, AND DISTANCE MEASURING SYSTEM

(71) Applicant: SONY SEMICONDUCTOR SOLUTIONS CORPORATION, KANAGAWA (JP)

(72) Inventor: NOBUHARU SUZUKI, KANAGAWA (JP)

(21) Appl. No.: 17/427,951

(22) PCT Filed: Feb. 4, 2020
(86) PCT No.: PCT/JP2020/004006

§ 371 Date: Aug. 3, 2021

(30) Foreign Application Priority Data
Feb. 13, 2019 (JP) 2019-023662

(51) Int. Cl. G01S 17/14; G01S 7/481; G01S 7/4863

(52) U.S. Cl. CPC G01S 17/14; G01S 7/4863; G01S 7/4816

(57) ABSTRACT

The present technology relates to a light receiving device, a histogram generating method, and a distance measuring system that are capable of realizing a histogram generating circuit with a small area and low power consumption.

A light receiving device includes: a measuring unit that measures time information from a light emission timing of a light source to a light reception timing at which a light receiving element receives light; a storage unit that stores a plurality of pieces of the time information; and a merge circuit that merges the same pieces of the time information measured by the measuring unit into one piece of time information, and a histogram generating circuit that generates a histogram on the basis of one or more types of the time information after merging. The present technology can be applied to, for example, such as a distance measuring system that detects a distance to a subject in a depth direction and the like.

### TECHNICAL FIELD

The present technology relates to a light receiving device, a histogram generating method, and a distance measuring system, and more particularly, to a light receiving device, a histogram generating method, and a distance measuring system that are capable of realizing a histogram generating circuit with a small area and low power consumption.

### BACKGROUND ART

One of distance measuring sensors that measure a distance to a subject is a direct time of flight (ToF) sensor (see, for example, Patent Document 1). The direct ToF sensor (hereinafter, simply referred to as the ToF sensor) directly measures a distance from time when light is projected toward a subject and time when reflected light reflected from the subject is received.

In the ToF sensor, a flight time of light from the time when the light is projected to the time when the reflected light is received is converted into distance data (hereinafter, the data is referred to as ToF data) by a time to digital converter (TDC), but the projection and reception of the light are performed a plurality of times in order to remove the influence of disturbance light and multipath. Then, a histogram of the plurality of times of ToF data is generated, and the ToF data having the largest frequency value is output as final ToF data.

In the ToF sensor, the ToF data is output from the TDC at a high rate due to the influence of the disturbance light, the multipath light, or the false light reception reaction due to noise, but in order to generate the histogram without missing the data, a histogram generating circuit also needs to be operated at a high rate that is the same as the output rate from the TDC.

### CITATION LIST

### Patent Document

Patent Document 1: Japanese Patent Application Laid-Open No. 2010-91377

### SUMMARY OF THE INVENTION

### Problems to be Solved by the Invention

However, in a case where the histogram generating circuit is operated at a high rate corresponding to the output rate from the TDC, an area and operating power of the histogram generating circuit increase. This problem becomes more remarkable in the future as a resolution of the ToF sensor is improved.

The present technology has been made in view of such a situation, and an object thereof is to realize a histogram generating circuit with a small area and low power consumption.

### Solution to Problems

A light receiving device according to a first aspect of the present technology includes: a measuring unit that measures time information from a light emission timing of a light source to a light reception timing at which a light receiving element receives light; a storage unit that stores a plurality of pieces of the time information; a merge circuit that merges the same pieces of the time information measured by the measuring unit into one piece of time information; and a histogram generating circuit that generates a histogram on the basis of one or more types of the time information after merging.

A histogram generating method according to a second aspect of the present technology is a histogram generating method including: a light receiving device measuring and storing time information from a light emission timing of a light source to a light reception timing at which a light receiving element receives light; the light receiving device merging the same pieces of the time information that are measured into one piece of time information; and the light receiving device generating a histogram on the basis of one or more types of the time information after merging.

A distance measuring system according to a third aspect of the present technology includes: a lighting device including a light source that emits irradiation light; and a light receiving device that receives reflected light of the irradiation light, in which the light receiving device includes: a measuring unit that measures time information from a light emission timing of the light source to a light reception timing at which a light receiving element of the light receiving device receives light; a storage unit that stores a plurality of pieces of the time information; and a merge circuit that merges the same pieces of the time information measured by the measuring unit into one piece of time information, and a histogram generating circuit that generates a histogram on the basis of one or more types of the time information after merging.

In the first to third aspects of the present technology, the time information from the light emission timing of the light source to the light reception timing of light received by the light receiving element is measured, the plurality of pieces of the time information is stored, the same pieces of the measured time information are merged into one piece of time information, and the histogram is generated on the basis of one or more types of the time information after merging.

The light receiving device and the distance measuring system may be independent devices, or may be modules incorporated in other devices.

### BRIEF DESCRIPTION OF DRAWINGS

FIG. 1 is a block diagram illustrating a configuration example of one embodiment of a distance measuring system to which the present technology is applied.

FIG. 2 is a block diagram illustrating a configuration example of a light receiving device in FIG. 1.

FIG. 3 is a diagram illustrating a circuit configuration example of a pixel.

FIG. 4 is a diagram explaining an operation of the pixel in FIG. 3.

FIG. 5 is a block diagram illustrating a configuration example of a signal processing unit as a comparative example.

FIG. 6 is a diagram illustrating an example of a histogram generated by a histogram generating circuit.

FIG. 7 is a block diagram illustrating a first configuration example of a signal processing unit in FIG. 2.

FIG. 8 is a timing chart showing a histogram generating operation by the signal processing unit in FIG. 5.

FIG. 9 is a timing chart showing a histogram generating operation by the signal processing unit in FIG. 7.

FIG. 10 is a block diagram illustrating a second configuration example of the signal processing unit in FIG. 2.

FIG. 11 is a block diagram illustrating a third configuration example of the signal processing unit in FIG. 2.

FIG. 12 is a plan view illustrating an arrangement example of each unit in a case of being configured with one chip having a laminated structure of two substrates.

FIG. 13 is a plan view illustrating an arrangement example of each unit in a case of being configured with one chip having a laminated structure of three substrates.

FIG. 14 is a flowchart explaining distance measuring processing.

FIG. 15 is a diagram illustrating a usage example of the distance measuring system.

FIG. 16 is a block diagram illustrating an example of a schematic configuration of a vehicle control system.

FIG. 17 is an explanatory diagram illustrating an example of installation positions of a vehicle exterior information detection unit and an imaging unit.

### MODE FOR CARRYING OUT THE INVENTION

Modes for carrying out the present technology (hereinafter, referred to as an embodiment) is described below. Note that the description is given in the following order.

1. Configuration example of distance measuring system

2. Configuration example of light receiving device

3. Configuration example of pixel circuit

4. Configuration example of signal processing unit as comparative example

5. First configuration example of signal processing unit of present technology

6. Comparison of histogram generating operation

7. Second configuration example of signal processing unit of present technology

8. Third configuration example of signal processing unit of present technology

9. Example of chip configuration

10. Distance measuring processing by distance measuring system

11. Usage example of distance measuring system

12. Application example to mobile body

<1. Configuration Example of Distance Measuring System>

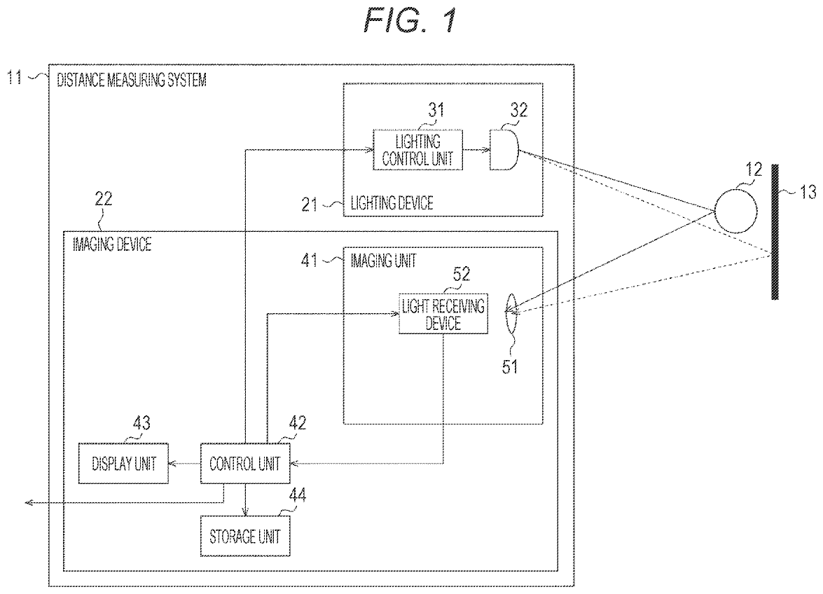

FIG. 1 is a block diagram illustrating a configuration example of one embodiment of a distance measuring system to which the present technology is applied.

A distance measuring system 11 is, for example, a system that captures a distance image using the ToF method. Here, the distance image is an image in which a distance in the depth direction from the distance measuring system 11 to a subject is detected in units of pixels, and a signal of each pixel includes a distance pixel signal based on the detected distance.

The distance measuring system 11 includes a lighting device 21 and an imaging device 22.

The lighting device 21 includes a lighting control unit 31 and a light source 32.

The lighting control unit 31 controls a pattern of light irradiation by the light source 32 under the control of a control unit 42 of the imaging device 22. Specifically, the lighting control unit 31 controls the pattern of light irradiation by the light source 32 according to an irradiation code included in an irradiation signal supplied from the control unit 42. For example, the irradiation code has two values of 1 (High) and 0 (Low), and the lighting control unit 31 turns on the light source 32 when the value of the irradiation code is 1 and turns off the light source 32 when the value of the irradiation code is 0.

The light source 32 emits light in a predetermined wavelength region under the control of the lighting control unit 31. The light source 32 includes, for example, an infrared laser diode. Note that the type of the light source 32 and the wavelength range of the irradiation light can be optionally set according to the application of the distance measuring system 11 and the like.

The imaging device 22 is a device that receives reflected light obtained by reflecting light (irradiation light) emitted from the lighting device 21 by a subject 12, a subject 13, and the like. The imaging device 22 includes an imaging unit 41, a control unit 42, a display unit 43, and a storage unit 44.

The imaging unit 41 includes a lens 51 and a light receiving device 52.

The lens 51 forms an image of incident light on a light receiving surface of the light receiving device 52. Note that the configuration of the lens 51 is optional, and for example, the lens 51 can be configured by a plurality of lens groups.

The light receiving device 52 includes, for example, a sensor using a single photon avalanche diode (SPAD) as a light receiving element for each pixel. Under the control of the control unit 42, the light receiving device 52 receives reflected light from the subject 12, the subject 13, and the like, converts a pixel signal obtained as a result thereof into distance information, and outputs the distance information to the control unit 42. The light receiving device 52 supplies, to the control unit 42, a distance image in which a digital count value obtained by counting the time from when the lighting device 21 emits irradiation light to when the light receiving device 52 receives the irradiation light is stored as a pixel value (distance pixel signal) of each pixel of a pixel array in which pixels are two-dimensionally arranged in a matrix in a row direction and a column direction. A light emission timing signal indicating the timing at which the light source 32 emits light is also supplied from the control unit 42 to the light receiving device 52.

Note that the distance measuring system 11 repeats light emission of the light source 32 and reception of reflected light thereof a plurality of times (for example, several thousands to several tens of thousands of times), to cause the imaging unit 41 to generate a distance image from which influence of disturbance light, multipath, and the like is removed, and supply the distance image to the control unit 42.

The control unit 42 includes, for example, a control circuit such as a field programmable gate array (FPGA) or a digital signal processor (DSP), a processor, and the like. The control unit 42 controls the lighting control unit 31 and the light receiving device 52. Specifically, the control unit 42 supplies an irradiation signal to the lighting control unit 31 and supplies the light emission timing signal to the light receiving device 52. The light source 32 emits irradiation light according to the irradiation signal. The light emission timing signal may be the irradiation signal supplied to the lighting control unit 31. Furthermore, the control unit 42 supplies the distance image acquired from the imaging unit 41 to the display unit 43 and causes the display unit 43 to display the distance image. Furthermore, the control unit 42 stores the distance image acquired from the imaging unit 41 in the storage unit 44. Furthermore, the control unit 42 outputs the distance image acquired from the imaging unit 41 to the outside.

The display unit 43 includes, for example, a panel type display device such as a liquid crystal display device or an organic electro luminescence (EL) display device.

The storage unit 44 can include an optional storage device, a storage medium, and the like, and stores a distance image and the like.

<2. Configuration Example of Light Receiving Device>

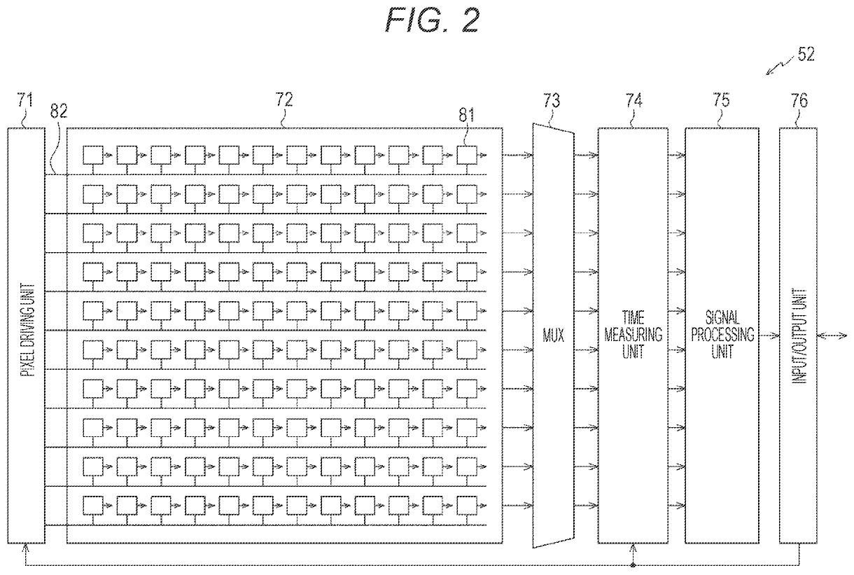

FIG. 2 is a block diagram illustrating a configuration example of the light receiving device 52.

The light receiving device 52 includes a pixel driving unit 71, a pixel array 72, a multiplexer (MUX) 73, a time measuring unit 74, a signal processing unit 75, and an input/output unit 76.

The pixel array 72 has a configuration in which pixels 81 that detect incidence of photons and output detection signals indicating a detection result as pixel signals are two-dimensionally arranged in a matrix in the row direction and the column direction. Here, the row direction refers to the arrangement direction of the pixels 81 in the horizontal direction, and the column direction refers to the arrangement direction of the pixels 81 in the vertical direction. In FIG. 2, the pixel array 72 is illustrated in a pixel array configuration of 10 rows and 12 columns due to paper surface restrictions, but the number of rows and the number of columns of the pixel array 72 are not limited thereto and are optional.

The pixel drive line 82 is horizontally wired for each pixel row in regard to the matrix pixel array of the pixel array 72. The pixel drive line 82 transmits a driving signal for driving the pixel 81. The pixel driving unit 71 drives each pixel 81 by supplying a predetermined driving signal to each pixel 81 via the pixel drive line 82. Specifically, the pixel driving unit 71 performs control such that at least some of the plurality of pixels 81 two-dimensionally arranged in a matrix are set as active pixels and the remaining pixels 81 are set as inactive pixels at a predetermined timing that matches with the light emission timing signal supplied from the outside via the input/output unit 76. The active pixel is a pixel that detects incidence of photons, and the inactive pixel is a pixel that does not detect incidence of photons. Naturally, all the pixels 81 of the pixel array 72 may be the active pixels. A detailed configuration of the pixel 81 is described later.

Note that, in FIG. 2, the pixel drive line 82 is illustrated as one piece of wiring, but may include a plurality of pieces of wiring. One end of the pixel drive line 82 is connected to an output terminal corresponding to each pixel row of the pixel driving unit 71.

The MUX 73 selects an output from the active pixel according to switching between the active pixel and the inactive pixel in the pixel array 72. Then, the MUX 73 outputs the pixel signal input from the selected active pixel to the time measuring unit 74.

On the basis of the pixel signal of the active pixel supplied from the MUX 73 and the light emission timing signal indicating the light emission timing of the light source 32, the time measuring unit 74 generates a count value corresponding to the time (light flight time) from when the light source 32 emits light to when the active pixel receives the light. The light emission timing signal is supplied from the outside (the control unit 42 of the imaging device 22) via the input/output unit 76.

The signal processing unit 75 generates, for each pixel, a histogram of the time (count value) until the reflected light is received, on the basis of the light emission of the light source 32 and the reception of the reflected light thereof repeatedly executed a predetermined number of times (for example, several thousands to several tens of thousands of times). Then, by detecting a peak of the histogram, the signal processing unit 75 determines the time until the light emitted from the light source 32 is reflected by the subject 12 or the subject 13 and returns. The signal processing unit 75 generates a distance image in which a digital count value obtained by counting the time until the light receiving device 52 receives the light is stored in each pixel, and supplies the distance image to the input/output unit 76. Alternatively, the signal processing unit 75 may perform calculation to obtain the distance to the object on the basis of the determined time and light speed, generate a distance image in which the calculation result is stored in each pixel, and supply the distance image to the input/output unit 76.

The input/output unit 76 outputs a signal of the distance image (distance image signal) supplied from the signal processing unit 75 to the outside (the control unit 42). Furthermore, the input/output unit 76 acquires the light emission timing signal supplied from the control unit 42, and supplies the light emission timing signal to the pixel driving unit 71 and the time measuring unit 74.

<3. Configuration Example of Pixel Circuit>

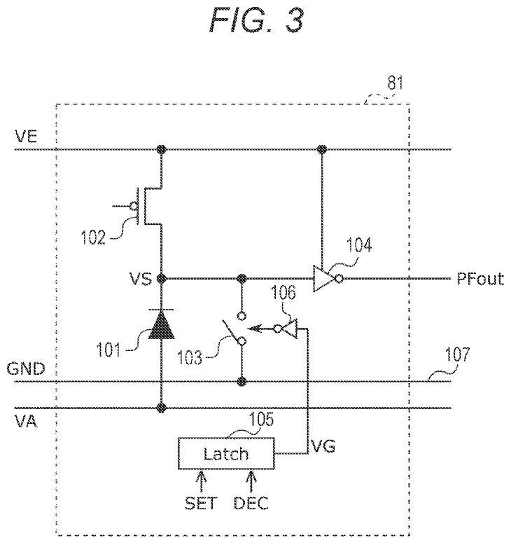

FIG. 3 illustrates a circuit configuration example of the plurality of pixels 81 arranged in a matrix in the pixel array 72.

The pixel 81 in FIG. 3 includes a SPAD 101, a transistor 102, a switch 103, and an inverter 104. The pixel 81 also includes a latching circuit 105 and an inverter 106. The transistor 102 includes a P-type MOS transistor.

A cathode of the SPAD 101 is connected to a drain of the transistor 102, and is connected to an input terminal of the inverter 104 and one end of the switch 103. An anode of the SPAD 101 is connected to a power supply voltage VA (hereinafter, also referred to as an anode voltage VA).

The SPAD 101 is a photodiode (single photon avalanche photodiode) that performs avalanche amplification of generated electrons and outputs a signal of a cathode voltage VS when incident light is incident. The power supply voltage VA supplied to the anode of the SPAD 101 is, for example, a negative bias (negative potential) of about −20 V.

The transistor 102 is a constant current source that operates in a saturation region, and performs passive quenching by acting as a quenching resistor. A source of the transistor 102 is connected to a power supply voltage VE, and the drain is connected to the cathode of the SPAD 101, the input terminal of the inverter 104, and one end of the switch 103. As a result, the power supply voltage VE is also supplied to the cathode of the SPAD 101. A pull-up resistor can also be used instead of the transistor 102 connected in series with the SPAD 101.

In order to detect light (photons) with sufficient efficiency, a voltage (hereinafter, referred to as an Excess Bias) larger than a breakdown voltage VBD of the SPAD 101 is applied to the SPAD 101. For example, assuming that the breakdown voltage VBD of the SPAD 101 is 20 V and a voltage larger than that by 3 V is applied, the power supply voltage VE supplied to the source of the transistor 102 is 3 V.

Note that the breakdown voltage VBD of the SPAD 101 greatly changes depending on the temperature and the like. Therefore, the applied voltage applied to the SPAD 101 is controlled (adjusted) according to the change in the breakdown voltage VBD. For example, when the power supply voltage VE is a fixed voltage, the anode voltage VA is controlled (adjusted).

Among both ends of the switch 103, one end is connected to the cathode of the SPAD 101, the input terminal of the inverter 104, and the drain of the transistor 102, and the other end is connected to a ground connection line 107 connected to the ground (GND). The switch 103 can include, for example, an N-type MOS transistor, and turns on and off a gating control signal VG, which is the output of the latching circuit 105, according to a gating inversion signal VG_I inverted by the inverter 106.

The latching circuit 105 supplies the gating control signal VG for controlling the pixel 81 to either the active pixel or the inactive pixel to the inverter 106 on the basis of a trigger signal SET supplied from the pixel driving unit 71 and address data DEC. The inverter 106 generates the gating inversion signal VG_I obtained by inverting the gating control signal VG, and supplies the gating inversion signal VG_I to the switch 103.

The trigger signal SET is a timing signal indicating a timing at which the gating control signal VG is switched, and the address data DEC is data indicating an address of a pixel to be set as the active pixel among the plurality of pixels 81 arranged in a matrix in the pixel array 72. The trigger signal SET and the address data DEC are supplied from the pixel driving unit 71 via the pixel drive line 82.

The latching circuit 105 reads the address data DEC at a predetermined timing indicated by the trigger signal SET. Then, in a case where a pixel address of its own (pixel 81) is included in the pixel address indicated by the address data DEC, the latching circuit 105 outputs the gating control signal VG of Hi (1) for setting the own pixel 81 as the active pixel. On the other hand, in a case where the pixel address of its own (pixel 81) is not included in the pixel address indicated by the address data DEC, the gating control signal VG of Lo (0) for setting the own pixel 81 as the inactive pixel is output. Accordingly, in a case where the pixel 81 is set as the active pixel, the gating inversion signal VG_I of Lo (0) inverted by the inverter 106 is supplied to the switch 103. On the other hand, in a case where the pixel 81 is the inactive pixel, the gating inversion signal VG_I of Hi (1) is supplied to the switch 103. Thus, the switch 103 is turned off (disconnected) in a case where the pixel 81 is set as the active pixel and turned on (connected) in a case where the inactive pixel is set.

The inverter 104 outputs a Hi detection signal PFout when the cathode voltage VS as an input signal is Lo, and outputs a Lo detection signal PFout when the cathode voltage VS is Hi. The inverter 104 is an output unit that outputs incidence of photons to the SPAD 101 as the detection signal PFout.

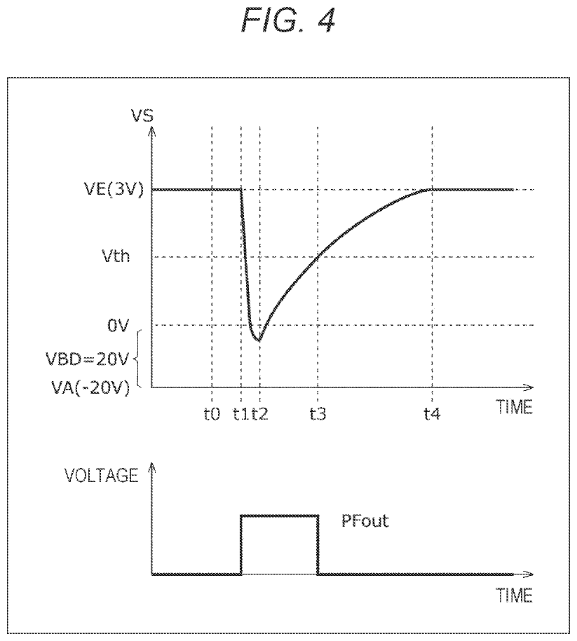

Next, an operation in a case where the pixel 81 is set as the active pixel is described with reference to FIG. 4.

FIG. 4 is a graph illustrating a change in the cathode voltage VS of the SPAD 101 in response to incidence of photons and the detection signal PFout.

First, in a case where the pixel 81 is the active pixel, the switch 103 is set to off as described above.

Because the power supply voltage VE (for example, 3 V) is supplied to the cathode of the SPAD 101 and the power supply voltage VA (for example, −20 V) is supplied to the anode, a reverse voltage larger than the breakdown voltage VBD (=20 V) is applied to the SPAD 101 to cause the SPAD 101 to be set to the Geiger mode. In this state, the cathode voltage VS of the SPAD 101 is the same as the power supply voltage VE, for example, as at time t0 in FIG. 4.

When photons are incident on the SPAD 101 set in the Geiger mode, avalanche multiplication occurs, and a current flows through the SPAD 101.

Assuming that avalanche multiplication occurs and the current flows through the SPAD 101 at time t1 in FIG. 4, the current also flows through the transistor 102 by the current flowing through the SPAD 101 at and after the time t1, and a voltage drop occurs due to a resistance component of the transistor 102.

When the cathode voltage VS of the SPAD 101 becomes lower than 0 V at time t2, an anode-to-cathode voltage of the SPAD 101 becomes lower than the breakdown voltage VBD, which causes the avalanche amplification to stop. Here, the operation of stopping the avalanche amplification by the current generated by the avalanche amplification flowing through the transistor 102 to generate the voltage drop and the cathode voltage VS becoming lower than the breakdown voltage VBD along with the generated voltage drop is a quenching operation.

When the avalanche amplification stops, the current flowing through the resistor of the transistor 102 gradually decreases, and at time t4, the cathode voltage VS returns to the original power supply voltage VE again, and a next new photon can be detected (recharge operation).

The inverter 104 outputs the detection signal PFout of Lo when the cathode voltage VS as an input voltage is equal to or more than a predetermined threshold voltage Vth, and outputs the detection signal PFout of Hi when the cathode voltage VS is less than the predetermined threshold voltage Vth. Therefore, when the photons are incident on the SPAD 101, the avalanche multiplication occurs, and the cathode voltage VS decreases and falls below the threshold voltage Vth, the detection signal PFout is inverted from a low level to a high level. On the other hand, when the avalanche multiplication of the SPAD 101 converges, and the cathode voltage VS rises and becomes equal to or more than the threshold voltage Vth, the detection signal PFout is inverted from the high level to the low level.

Note that, in a case where the pixel 81 is the inactive pixel, the gating inversion signal VG_I of Hi (1) is supplied to the switch 103, and the switch 103 is turned on. When the switch 103 is turned on, the cathode voltage VS of the SPAD 101 becomes 0 V. As a result, because the anode-to-cathode voltage of the SPAD 101 becomes equal to or less than the breakdown voltage VBD, the SPAD 101 is in a state in which no reaction occurs even if the photons enter therein.

<4. Configuration Example of Signal Processing Unit as Comparative Example>

As described above, the signal processing unit 75 generates the histogram of the count value corresponding to the time until the reflected light is received for each pixel, on the basis of the light emission of the light source 32 and the reception of the reflected light thereof repeatedly executed the predetermined number of times. The circuit area of the histogram generating circuit that generates the histogram increases when the resolution (spatial resolution or temporal resolution) of the distance measuring system is intended to be increased.

Therefore, hereinafter, a configuration of a signal processing unit that can suppress the circuit area of the histogram generating circuit applied to the signal processing unit 75 of the light receiving device 52 is described. However, in the following, first, a configuration example a signal processing unit 301 as a comparative example, which is to be compared with the signal processing unit 75 to which the present technology is applied, is described, and then, a configuration of the signal processing unit 75 of the light receiving device 52 is described.

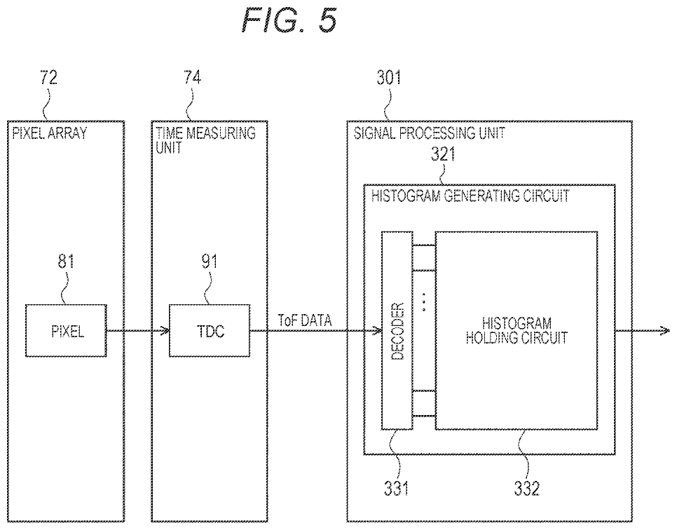

FIG. 5 is a block diagram illustrating a configuration example of the signal processing unit 301 as the comparative example.

The signal processing unit 301 in FIG. 5 includes one histogram generating circuit 321 corresponding to one time to digital converter (TDC) 91 provided in a time measuring unit 74, and the histogram generating circuit 321 includes a decoder 331 and a histogram holding circuit 332. The TDC 91 of the time measuring unit 74 is provided corresponding to one or more pixels 81 of the pixel array 72.

Note that the pixel array 72 and the time measuring unit 74 in FIG. 5 are illustrated to describe the correspondence relationship with the histogram generating circuit 321.

That is, the TDC 91 of the time measuring unit 74 is provided for one or more pixels 81 of the pixel array 72. For example, in a case where all the pixels 81 two-dimensionally arranged in a matrix are simultaneously operated as the active pixels, the pixels 81 and the TDCs 91 are provided on a one-to-one basis, and the time measuring unit 74 includes the same number of TDCs 91 as the number of pixels of the pixel array 72. Further, for example, in a case where one TDC 91 is provided for the plurality of pixels 81 constituting one row of the pixel array 72, the time measuring unit 74 includes the same number of TDCs 91 as the number of pixel rows of the pixel array 72. Therefore, the number of TDCs 91 included in the time measuring unit 74 is determined according to a request such as the number of pixels simultaneously set as the active pixels in a single light reception.

In the MUX 73, assuming that the output of the pixel 81 set as the active pixel is appropriately selected, the pixel signal of the pixel 81 set as the active pixel, that is, the above-described detection signal PFout is input to the TDC 91. The TDC 91 counts a time (period) when the Hi detection signal PFout is input, and outputs a count value which is a result of the counting to the histogram generating circuit 321 as ToF data. The TDC 91 corresponds to a measuring unit that measures time information from the light emission timing of the light source 32 to the light reception timing at which the pixel 81 receives light.

The ToF data input to the histogram generating circuit 321 is decoded by the decoder 331 and stored in a bin of the histogram of the histogram holding circuit 332. In other words, the decoder 331 selects the bin of the histogram of the histogram holding circuit 332 according to the input ToF data, and updates a frequency value of the histogram of the selected bin.

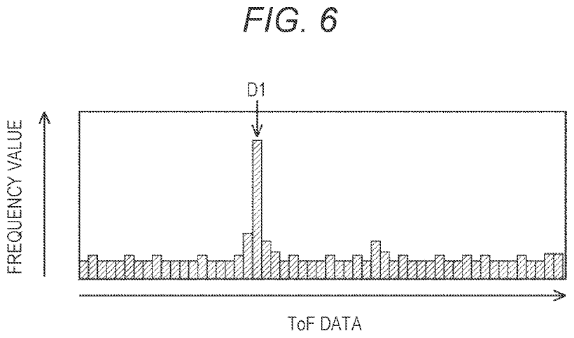

FIG. 6 illustrates an example of a histogram generated by the histogram generating circuit 321 by repeating light emission of the light source 32 and light reception of the reflected light thereof a plurality of times (for example, several thousands to several tens of thousands of times).

In the example of the histogram illustrated in FIG. 6, a bin indicated by D1 indicates a peak of the histogram, and ToF data (count value) of the bin indicated by D1 is output as the ToF data of the pixel 81.

<5. First Configuration Example of Signal Processing Unit of Present Technology>

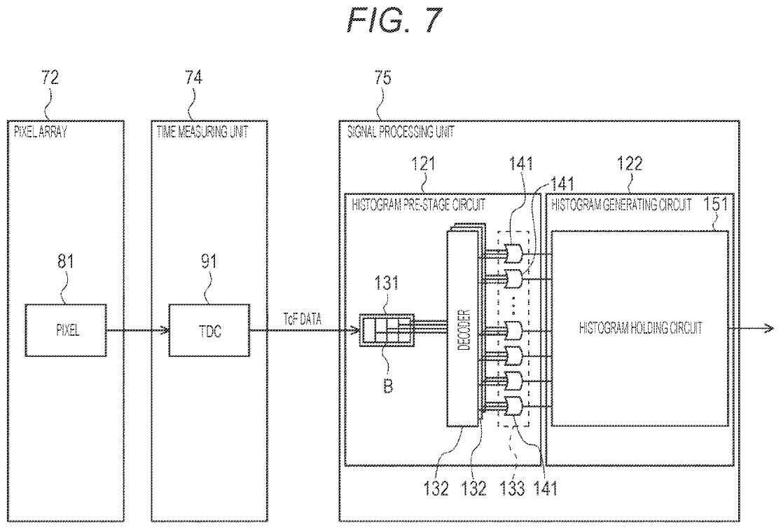

FIG. 7 is a block diagram illustrating a first configuration example of the signal processing unit 75 in FIG. 2, which is a signal processing unit to which the present technology is applied.

Note that, also in FIG. 7, similarly to FIG. 5, corresponding configurations of the pixel array 72 and the time measuring unit 74 are illustrated.

The signal processing unit 75 in FIG. 7 includes one histogram pre-stage circuit 121 and a histogram generating circuit 122 corresponding to one TDC 91 provided in the time measuring unit 74. The relationship between the pixel 81 of the pixel array 72 and the TDC 91 of the time measuring unit 74 is similar to that in the case of FIG. 5.

The histogram pre-stage circuit 121 includes a storage unit 131 including a buffer B that stores a plurality of pieces of ToF data, a plurality of decoders 132, and a merge circuit 133. The histogram generating circuit 122 includes a histogram holding circuit 151. The histogram holding circuit 151 can include, for example, a flip-flop (FF) array, a static RAM (SRAM), and the like.

The storage unit 131 stores one or more types of ToF data input from the TDC 91 in the buffer B during a single distance measuring period. The buffer B is configured to be able to store a plurality of pieces of ToF data corresponding to a plurality of times of avalanche amplification, such as the disturbance light, the multipath light, or the false light reception reaction due to noise, generated during the single distance measuring period. Then, the number of decoders 132 corresponding to the number of pieces of ToF data storable in the buffer B is prepared. For example, assuming that the buffer B can store five pieces of ToF data, the number of decoders 132 provided in the histogram pre-stage circuit 121 is five.

Each of the plurality of decoders 132 acquires one piece of ToF data stored in the buffer B and outputs the ToF data to the merge circuit 133. The merge circuit 133 includes an OR cell column in which a plurality of OR circuits is arranged. Each OR circuit is connected to an output terminal of the same pieces of ToF data of the plurality of decoders 132, and the merge circuit 133 has the OR circuits of the number of pieces of data of the ToF data that can be taken. The merge circuit 133 merges the same pieces of ToF data among the plurality of pieces of ToF data stored in the buffer B into one piece of ToF data and outputs the ToF data to the histogram holding circuit 151 of the histogram generating circuit 122.

The histogram holding circuit 151 updates and stores the frequency value of the histogram of the bin corresponding to the ToF data on the basis of one or more types of ToF data after the merge by the merge circuit 133. Then, the histogram holding circuit 151 generates a histogram of the ToF data by updating the frequency value of the histogram in accordance with the reception of the reflected light of the light source 32 for a plurality of times (for example, several thousands to several tens of thousands of times).

The signal processing unit 75 generates a distance image in which the ToF data corresponding to the peak of the histogram of each pixel 81 of the pixel array 72 is stored in each pixel, and supplies the distance image to the input/output unit 76. Alternatively, the signal processing unit 75 may perform calculation to obtain the distance to the object on the basis of the determined time and light speed, generate a distance image in which the calculation result is stored in each pixel, and supply the distance image to the input/output unit 76.

<6. Comparison of Histogram Generating Operation>

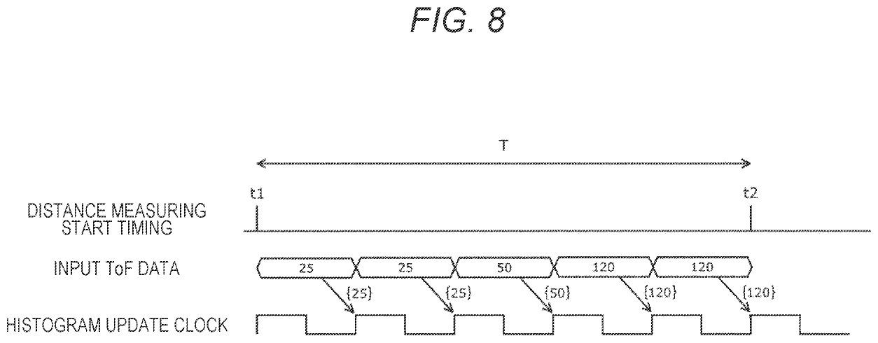

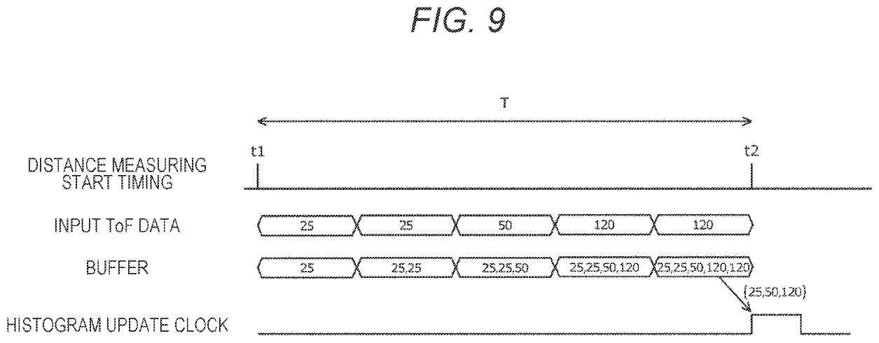

With reference to FIGS. 8 and 9, histogram generating operations by the signal processing unit 75 in FIG. 7 and the signal processing unit 301 in FIG. 5 as the comparative example are compared.

FIG. 8 is a timing chart illustrating the histogram generating operation by the signal processing unit 301 in FIG. 5 as the comparative example.

FIG. 9 is a timing chart illustrating the histogram generating operation by the signal processing unit 75 in FIG. 7.

In both FIGS. 8 and 9, it is assumed that a period T from time t1 to time t2 corresponds to the single distance measuring period, and five pieces of ToF data of 25, 25, 50, 120, and 120 are output from the TDC 91 in the single distance measuring period T. By repeating the measurement of the distance measuring period T a plurality of times (for example, several thousands to several tens of thousands of times), the final histogram is generated. Note that a signal for identifying the single distance measuring period is supplied as the light emission timing signal from the control unit 42 of the imaging device 22 to the light receiving device 52.

As illustrated in FIG. 8, the histogram generating circuit 321 of the signal processing unit 301 in FIG. 5 as the comparative example updates the histogram of the histogram holding circuit 332 every time the ToF data is input from the TDC 91. Specifically, the ToF data is updated every time the ToF data of {25}, {25}, {50}, {120}, or {120} is input. The histogram generating circuit 321 needs to be operated at a speed at which all the sequentially input pieces of ToF data can be processed.

On the other hand, as illustrated in FIG. 9, in the signal processing unit 75 in FIG. 7, the five pieces of ToF data sequentially input from the TDC 91 are stored in the buffer B of the storage unit 131 of the histogram pre-stage circuit 121. Then, at the timing when the single distance measuring period T ends, the same pieces of ToF data is merged into one piece of ToF data by the merge circuit 133, and the one or more types of ToF data after the merging are collectively supplied to the histogram holding circuit 151 of the histogram generating circuit 122 once. Specifically, the pieces of ToF data of {25}, {50}, and {120} are collectively supplied to the histogram generating circuit 122 at a single time, and the histogram is updated.

Therefore, in the signal processing unit 75, all the one or more types of ToF data supplied to the histogram holding circuit 151 have different count values. In addition, the timing of updating the histogram does not need to be the timing of each input of the ToF data, and may be the timing of each distance measuring period T.

In a case where five pieces of ToF data of 25, 25, 50, 120, and 120 are output from the TDC 91 in the single distance measuring period T, in the histogram generating circuit 321 of the comparative example, the frequency value of the ToF data of {25} is integrated by 2, the frequency value of the ToF data of {120} is integrated by 2, and the frequency value of the ToF data of {50} is integrated by 1, whereas in the histogram holding circuit 151, the frequency values of the pieces of ToF data of {25}, {50}, and {120} are only integrated by 1.

Therefore, according to the signal processing unit 75 of the light receiving device 52, a correct histogram, in other words, a histogram having the same frequency value as the number of outputs of the pieces of ToF data output by the TDC 91 cannot be created.

However, only in the distance measuring system by the direct ToF method, it is not necessary to create the correct histogram. The reason is as follows.

In the direct ToF method, the TDC 91 of the time measuring unit 74 performs a counting operation of starting counting from the count value=0 at the start time of the single distance measuring period T (time t1 in FIG. 9) and counting up the count value until the end time of the distance measuring period T (time t2 in FIG. 9). Therefore, normally, the same pieces of ToF data are not output from the TDC 91, and in a case where the same pieces of ToF data are output from the TDC 91, the ToF data is considered to be a noise operation of the pixel 81. Therefore, it is not necessary to integrate a plurality of the same pieces of ToF data for the single distance measuring period T, but rather, it can be said that the merge circuit 133 is removing the noise of the ToF data. That is, the merge circuit 133 also has a noise removal function by a low-pass filter operation.

Therefore, even in the above-described operation, the distance image can be accurately generated by generating the histogram based on the result of repeating the single distance measuring period T a plurality of times (for example, several thousands to several tens of thousands of times).

As described above, according to the signal processing unit 75 in FIG. 7, the update frequency of the histogram may be the timing of the distance measuring period T, and it is not necessary to perform the operation at a high rate up to the output rate of the ToF data from the TDC 91. Therefore, the histogram generating circuit which is a memory unit holding the histogram can be realized with a small area and low power consumption.

<7. Second Configuration Example of Signal Processing Unit of Present Technology>

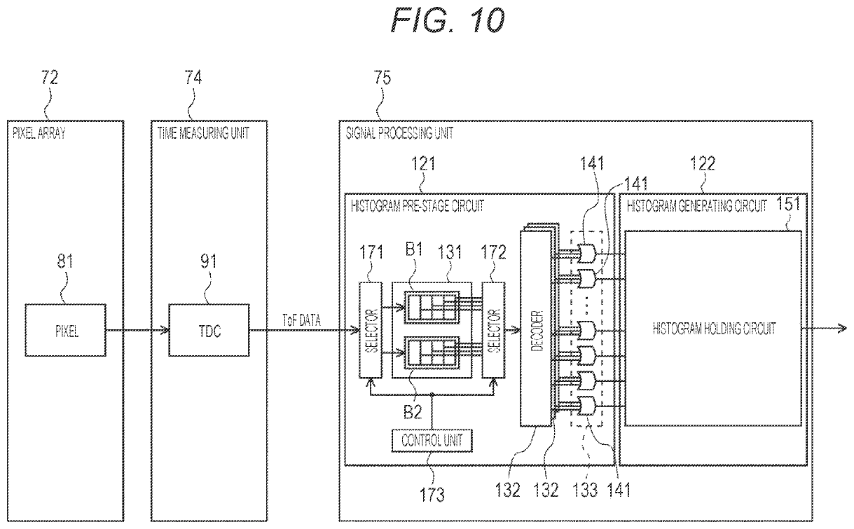

FIG. 10 is a block diagram illustrating a second configuration example of the signal processing unit 75 in FIG. 2.

In FIG. 10, parts corresponding to those in FIG. 7 are denoted by the same reference numerals, and the description of the parts are omitted as appropriate.

The second configuration example in FIG. 10 is different from the first configuration example in a part of the histogram pre-stage circuit 121. Specifically, the storage unit 131 of the second configuration example includes two buffers B, one of which is included in the storage unit 131 of the first configuration example. The two buffers B included in the storage unit 131 of the second configuration example are referred to as a buffer B1 (first storage area) and a buffer B2 (second storage area).

Further, the histogram pre-stage circuit 121 of the second configuration example includes the plurality of decoders 132 and the merge circuit 133 similarly to the first configuration example, and further includes selectors 171 and 172 and a control unit 173.

The selector 171 stores one or more pieces of ToF data input from the TDC 91 in the single distance measuring period T in either the buffer B1 or B2 under the control of the control unit 173. According to the control of the control unit 173, the selector 172 reads one or more pieces of ToF data stored in the buffer B1 or B2 from one of the buffers B1 and B2, and outputs the ToF data to the plurality of decoders 132.

The control unit 173 controls an output destination of the ToF data of the selector 171 and a read target of the ToF data of the selector 172. More specifically, in a case where the selector 171 outputs the ToF data from the TDC 91 to the buffer B1, the control unit 173 causes the selector 172 to read the ToF data from the buffer B2, and in a case where the selector 171 outputs the ToF data from the TDC 91 to the buffer B2, the control unit causes the selector 172 to read the ToF data from the buffer B1. As a result, the storage of the ToF data in the buffer B1 and the output of the ToF data stored in the buffer B2 to the merge circuit 133 are simultaneously executed. That is, because the output of the ToF data from the TDC 91 and the histogram update can be operated in parallel, the processing can be speeded up.

Also in the signal processing unit 75 in FIG. 10, the update frequency of the histogram may be the timing of the distance measuring period T, and it is not necessary to perform the operation at a high rate up to the output rate of the ToF data from the TDC 91. Therefore, the histogram generating circuit which is the memory unit holding the histogram can be realized with a small area and low power consumption.

<8. Third Configuration Example of Signal Processing Unit of Present Technology>

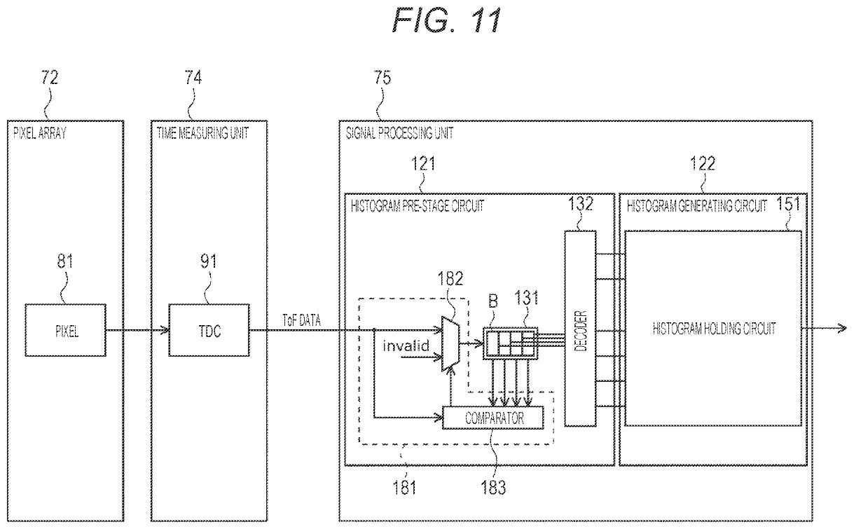

FIG. 11 is a block diagram illustrating a third configuration example of the signal processing unit 75 in FIG. 2.

In FIG. 11, parts corresponding to those in FIG. 7 are denoted by the same reference numerals, and the description of the parts are omitted as appropriate.

The third configuration example of FIG. 11 is different from the first configuration example in a part of the histogram pre-stage circuit 121. Specifically, the histogram pre-stage circuit 121 of the third configuration example is provided with a merge circuit 181 instead of the merge circuit 133 of the first configuration example. Furthermore, in the first configuration example, the number of decoders 132 corresponding to the number of ToF data storable in the buffer B is provided, but in the third configuration example, the number of decoders 132 is one.

The merge circuit 181 is provided in a preceding stage of the storage unit 131 (buffer B) and includes a selector 182 (selection unit) and a comparator 183.

The selector 182 selects either the input from the TDC 91 or invalid according to the control of the comparator 183. In a case where the input from the TDC 91 is selected, the selector 182 stores the ToF data from the TDC 91 in the buffer B of the storage unit 131, and in a case where the invalid is selected, the selector does not store the ToF data from the TDC 91 in the buffer B of the storage unit 131.

The comparator 183 compares the ToF data supplied from the TDC 91 with the ToF data stored in the buffer B of the storage unit 131, and in a case where the ToF data supplied from the TDC 91 is data already stored in the buffer B, the selector 182 performs control so as not to output the ToF data from the TDC 91 to the buffer B. On the other hand, in a case where the ToF data supplied from the TDC 91 is data not stored in the buffer B, the comparator 183 causes the selector 182 to output the ToF data from the TDC 91 to the buffer B.

Therefore, the merge circuit 181 determines whether the ToF data input from the TDC 91 is stored in the buffer B of the storage unit 131, and stores the ToF data input from the TDC 91 in the buffer B in a case where the ToF data is not stored in the buffer B.

Also in the signal processing unit 75 in FIG. 11, the update frequency of the histogram may be the timing of the distance measuring period T, and it is not necessary to perform the operation at a high rate up to the output rate of the ToF data from the TDC 91. Therefore, the histogram generating circuit which is the memory unit holding the histogram can be realized with a small area and low power consumption.

Note that, in the third configuration example, the merge circuit 181 needs to be operated at a speed equal to or more than the output rate of the TDC 91.

<9. Example of Chip Configuration>

The light receiving device 52 can include one chip (semiconductor chip) having a laminated structure in which two or three substrates (dies) are laminated.

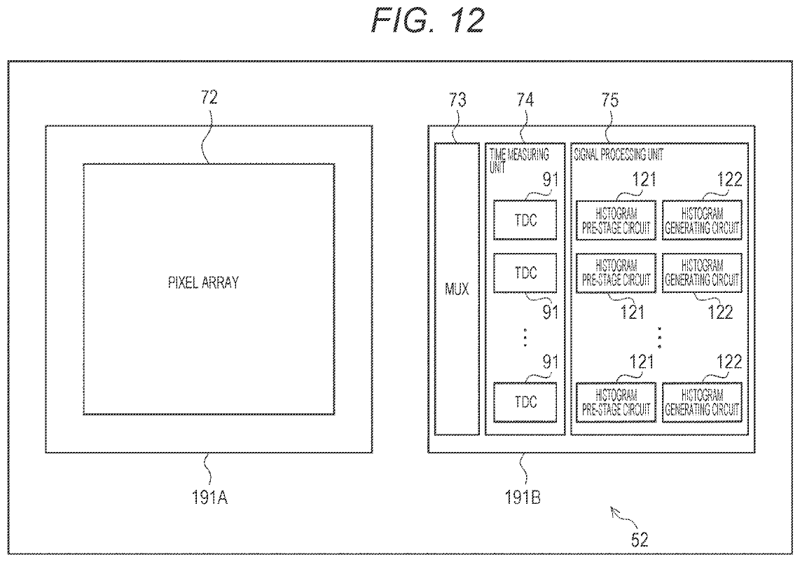

FIG. 12 illustrates an arrangement example of each unit in a case where the light receiving device 52 includes one chip having a laminated structure of two substrates.

The light receiving device 52 is configured by laminating a first substrate 191A and a second substrate 191B. The first substrate 191A and the second substrate 191B are electrically connected by, for example, a through via or Cu—Cu metal bonding.

A light receiving surface that receives the reflected light is provided on the first substrate 191A, and the pixel array 72 is formed on the first substrate 191A. The MUX 73, the time measuring unit 74, the signal processing unit 75, and the like are arranged on the second substrate 191B. An input/output terminal such as a solder ball, which is a part of the input/output unit 76, is formed, for example, on a surface of the second substrate 191B on the opposite side to the bonding surface of the first substrate 191A. The pixel driving unit 71 (not illustrated) may be formed on either the first substrate 191A or the second substrate 191B.

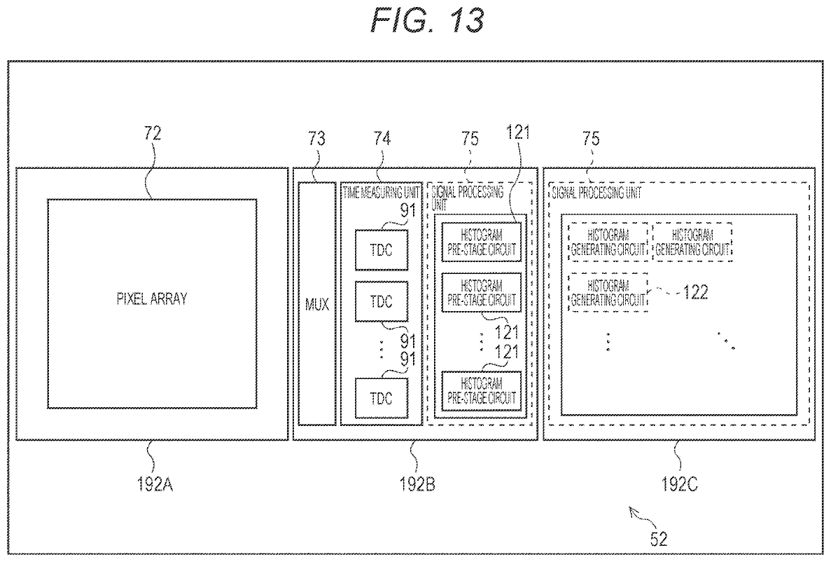

FIG. 13 illustrates an arrangement example of each unit in a case where the light receiving device 52 includes one chip having a laminated structure of three substrates.

The light receiving device 52 is configured by laminating a first substrate 192A, a second substrate 192B, and a third substrate 192C. The first substrate 192A and the second substrate 192B are electrically connected by a through via or metal bonding of Cu—Cu, and the second substrate 192B and the third substrate 192C are electrically connected by a through via or metal bonding of Cu—Cu.

The pixel array 72 is formed on the first substrate 192A. On the second substrate 192B, the MUX 73, the time measuring unit 74, and the plurality of histogram pre-stage circuits 121 which is a part of the signal processing unit 75 are arranged.

On the third substrate 192C, the remaining of the signal processing unit 75 not arranged on the second substrate 192B, for example, the plurality of histogram generating circuits 122, the input/output unit 76, and the like are arranged. For example, an SRAM as the plurality of histogram generating circuits 122 is connected to the output terminal of each histogram pre-stage circuit 121 of the second substrate 192B by a through silicon via (TSV) or the like.

<10. Distance Measuring Processing by Distance Measuring System>

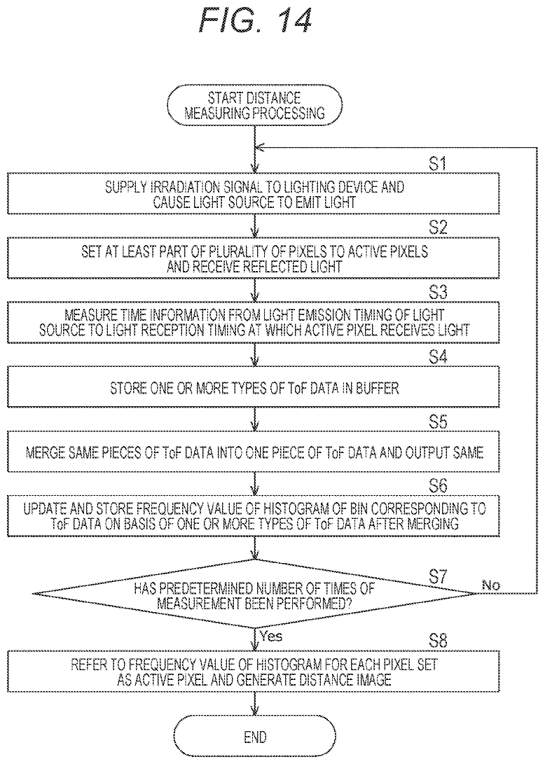

Next, distance measuring processing by the distance measuring system 11 is described with reference to a flowchart in FIG. 14. This processing is started, for example, when an instruction to start the distance measuring processing is given to the imaging device 22 of the distance measuring system 11. Note that, in FIG. 14, a case where the signal processing unit 75 is the first configuration example illustrated in FIG. 7 is described.

First, in step S1, the control unit 42 of the imaging device 22 supplies the irradiation signal to the lighting control unit 31 of the lighting device 21 to cause the light source 32 to emit light. The light source 32 emits the light in a predetermined wavelength region according to the irradiation code included in the irradiation signal. A light emission timing signal indicating the timing at which the light source 32 emits light is also supplied from the control unit 42 to the light receiving device 52.

In step S2, the light receiving device 52 sets at least a part of the plurality of pixels 81 of the pixel array 72 as the active pixels, and receives the reflected light which is the light emitted from the light source 32 and reflected by the subject. The pixel 81 set as the active pixel detects incidence of photons to the SPAD 101 and outputs the Hi detection signal PFout to the TDC 91.

In step S3, the TDC 91 measures the time information from the light emission timing of the light source 32 to the light reception timing at which the active pixel receives light. Specifically, the TDC 91 counts a time (period) when the Hi detection signal PFout is input, and outputs a count value which is a result of the counting to the histogram generating circuit 122 as the ToF data. Here, in the TDC 91, there is a case where a plurality of times of avalanche amplification occurs during the single distance measuring period due to the disturbance light, the multipath light, the false light reception reaction due to noise, or the like, and one or more types of the plurality of pieces of ToF data are supplied to the histogram generating circuit 122 corresponding to the plurality of times of avalanche amplification.

In step S4, the storage unit 131 stores one or more types of ToF data input from the TDC 91 in the buffer B.

In step S5, the merge circuit 133 acquires the one or more types of ToF data stored in the buffer B via the decoder 132, merges the same pieces of ToF data among the one or more types of ToF data into one piece of ToF data, and outputs the ToF data to the histogram holding circuit 151 of the histogram generating circuit 122.

In step S6, the histogram holding circuit 151 updates and stores the frequency value of the histogram of the bin corresponding to the ToF data on the basis of one or more types of ToF data after the merging supplied from the merge circuit 133.

In step S7, the control unit 42 determines whether the measurement has been performed a predetermined number of times (for example, several thousands to several tens of thousands of times) determined in advance.

In a case where it is determined in step S7 that the measurement has not been performed the predetermined number of times, the processing returns to step S1, and the above-described processing is repeated. As a result, the processing of steps S1 to S7 is repeated the predetermined number of times (for example, several thousands to several tens of thousands of times) determined in advance.

On the other hand, in a case where it is determined in step S7 that the predetermined number of times of measurement has been performed, the processing proceeds to step S8, and the signal processing unit 75 refers to the frequency value of the histogram of the histogram holding circuit 151 for each pixel 81 set as the active pixel, generates a distance image in which the ToF data corresponding to the peak is stored as the pixel value, and supplies the distance image to the control unit 42 via the input/output unit 76. The control unit 42 outputs the distance image acquired from the imaging unit 41 to the outside, and ends the distance measuring processing.

Note that the signal processing unit 75 may perform up to calculation to obtain the distance to the object on the basis of the determined time (ToF data) and the light speed, generate a distance image in which the calculation result is stored in each pixel, and supply the distance image to the control unit 42.

As described above, the distance image is generated by the distance measuring system 11 and output to the outside.

Note that the distance measuring processing in a case where the second configuration example illustrated in FIG. 10 is adopted as the configuration of the signal processing unit 75 is similar to the above-described flowchart in FIG. 14. However, in the distance measuring processing in a case where the third configuration example illustrated in FIG. 11 is adopted, because the ToF data is merged by the merge circuit 181 and then stored in the buffer B, the order of the processing in step S4 and step S5 described above is switched.

According to the light receiving device 52 of the distance measuring system 11, the update frequency of the histogram may be the timing of the distance measuring period T, and it is not necessary to operate the signal processing unit 75 at a high rate up to the output rate of the ToF data from the TDC 91. Therefore, the histogram generating circuit which is a memory unit holding the histogram can be realized with a small area and low power consumption.

<11. Usage Example of Distance Measuring System>

The present technology is not limited to application to the distance measuring system. That is, the present technology is applicable to, for example, general electronic devices such as a smartphone, a tablet terminal, a mobile phone, a personal computer, a game machine, a television receiver, a wearable terminal, a digital still camera, and a digital video camera. The above-described imaging unit 41 may have a modular form in which the lens 51 and the light receiving device 52 are packaged together, or the lens 51 and the light receiving device 52 may be configured separately, and only the light receiving device 52 may be configured as one chip.

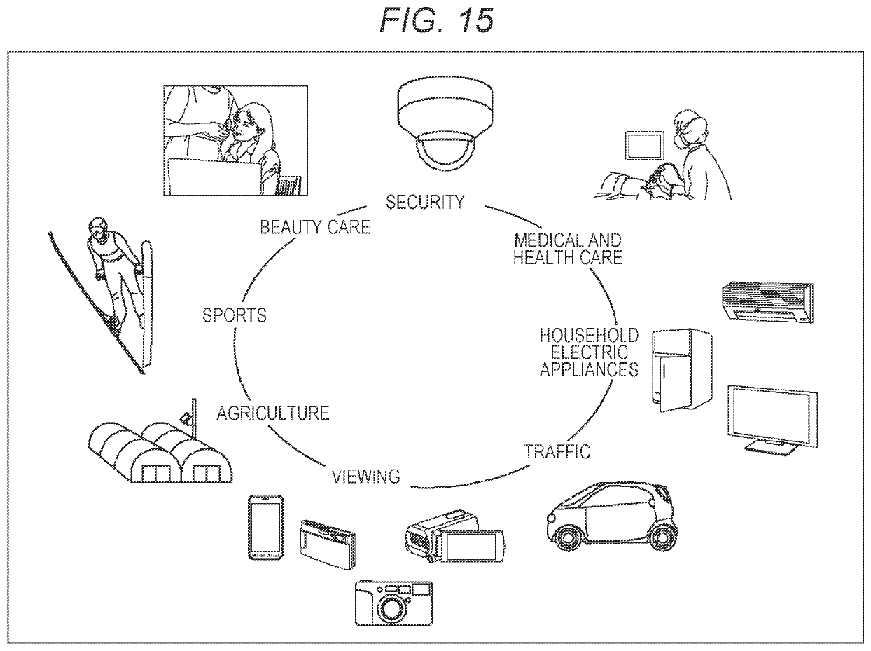

FIG. 15 is a diagram illustrating a usage example of the distance measuring system 11 or the light receiving device 52 described above.

The above-described distance measuring system 11 can be used, for example, in various cases of sensing light such as visible light, infrared light, ultraviolet light, and X-rays as described below.
A device such as a digital camera or a portable device with a camera function that captures an image to be used for viewing
A device used for traffic, such as an on-board sensor that captures images of the front, rear, surroundings, interior, and the like of an automobile for safe driving such as automatic stop, recognition of a driver's condition, and the like, a monitoring camera that monitors traveling vehicles and roads, and a distance measuring sensor that measures a distance between vehicles and the like
A device used for household electric appliances such as a TV, a refrigerator, and an air conditioner in order to capture an image of a user's gesture and perform an appliance operation according to the gesture
A device used for medical or health care, such as an endoscope or a device that performs angiography by receiving infrared light
A device used for security, such as a monitoring camera for crime prevention or a camera for person authentication
A device used for beauty care, such as a skin measuring instrument for imaging the skin or a microscope for imaging the scalp
An apparatus used for sports and the like, such as an action camera or a wearable camera for sports
A device used for agriculture, such as a camera for monitoring conditions of fields and crops

<12. Application Example to Mobile Body>

The technology according to the present disclosure (present technology) can be applied to various products. For example, the technology according to the present disclosure may be realized as a device mounted on any type of mobile body such as an automobile, an electric vehicle, a hybrid electric vehicle, a motorcycle, a bicycle, a personal mobility, an airplane, a drone, a ship, and a robot.

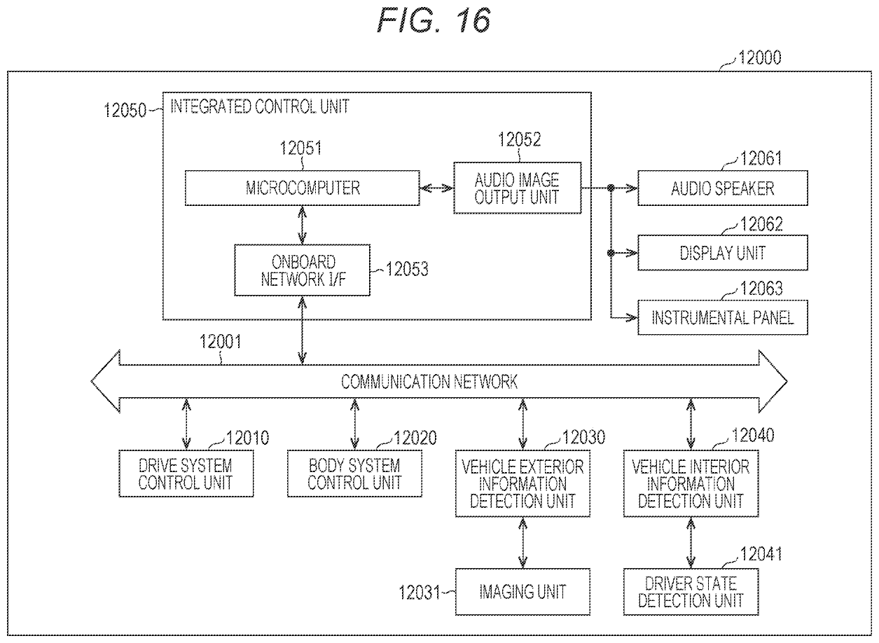

FIG. 16 is a block diagram illustrating a schematic configuration example of a vehicle control system which is an example of a mobile body control system to which the technology according to the present disclosure can be applied.

The vehicle control system 12000 includes a plurality of electronic control units connected via a communication network 12001. In the example illustrated in FIG. 16, the vehicle control system 12000 includes a drive system control unit 12010, a body system control unit 12020, a vehicle exterior information detection unit 12030, a vehicle interior information detection unit 12040, and an integrated control unit 12050. Furthermore, as a functional configuration of the integrated control unit 12050, a microcomputer 12051, an audio image output unit 12052, and an on-board network interface (I/F) 12053 are illustrated.

The drive system control unit 12010 controls the operation of devices related to the drive system of a vehicle according to various programs. For example, the drive system control unit 12010 functions as a control device of a driving force generating device for generating a driving force of the vehicle such as an internal combustion engine or a driving motor, a driving force transmission mechanism for transmitting the driving force to wheels, a steering mechanism for adjusting a steering angle of the vehicle, a braking device for generating a braking force of the vehicle, and the like.

The body system control unit 12020 controls operations of various devices mounted on the vehicle body according to various programs. For example, the body system control unit 12020 functions as a control device of a keyless entry system, a smart key system, a power window device, or various lamps such as a head lamp, a back lamp, a brake lamp, a blinker, or a fog lamp. In this case, radio waves transmitted from a portable device that substitutes for a key or signals of various switches can be input to the body system control unit 12020. The body system control unit 12020 receives input of these radio waves or signals, and controls a door lock device, a power window device, a lamp, and the like of the vehicle.

The vehicle exterior information detection unit 12030 detects information outside the vehicle on which the vehicle control system 12000 is mounted. For example, an imaging unit 12031 is connected to the vehicle exterior information detection unit 12030. The vehicle exterior information detection unit 12030 causes the imaging unit 12031 to capture an image of the vehicle exterior, and receives the captured image. The vehicle exterior information detection unit 12030 may perform object detection processing or distance detection processing of a person, a vehicle, an obstacle, a sign, a character on a road surface, and the like on the basis of the received image.

The imaging unit 12031 is an optical sensor that receives light and outputs an electric signal corresponding to an amount of the received light. The imaging unit 12031 can output the electric signal as an image or can output the electric signal as distance measuring information. Furthermore, the light received by the imaging unit 12031 may be visible light or invisible light such as infrared rays.

The vehicle interior information detection unit 12040 detects vehicle interior information. For example, a driver state detection unit 12041 that detects a state of a driver is connected to the vehicle interior information detection unit 12040. The driver state detection unit 12041 includes, for example, a camera that images the driver, and the vehicle interior information detection unit 12040 may calculate a degree of fatigue or a degree of concentration of the driver, or may determine whether or not the driver is dozing off on the basis of detection information input from the driver state detection unit 12041.

The microcomputer 12051 can calculate a control target value of the driving force generating device, the steering mechanism, or the braking device on the basis of the vehicle interior or exterior information acquired by the vehicle exterior information detection unit 12030 or the vehicle interior information detection unit 12040, and output a control command to the drive system control unit 12010. For example, the microcomputer 12051 can perform cooperative control for the purpose of implementing functions of an advanced driver assistance system (ADAS) including collision avoidance or impact mitigation of the vehicle, follow-up traveling based on an inter-vehicle distance, vehicle speed maintenance traveling, vehicle collision warning, vehicle lane departure warning, and the like.

Furthermore, by controlling the driving force generating device, the steering mechanism, the braking device, and the like on the basis of the information around the vehicle acquired by the vehicle exterior information detection unit 12030 or the vehicle interior information detection unit 12040, the microcomputer 12051 can perform cooperative control for the purpose of automatic driving and the like in which the vehicle autonomously travels without depending on the operation of the driver.

Furthermore, the microcomputer 12051 can output a control command to the body system control unit 12020 on the basis of the vehicle exterior information acquired by the vehicle exterior information detection unit 12030. For example, the microcomputer 12051 can perform cooperative control for the purpose of preventing glare, such as switching from a high beam to a low beam, by controlling the headlamp according to a position of a preceding vehicle or an oncoming vehicle detected by the vehicle exterior information detection unit 12030.

The audio image output unit 12052 transmits an output signal of at least one of audio or an image to an output device that can visually or audibly notifying a vehicle occupant or the vehicle exterior of information. In the example of FIG. 16, an audio speaker 12061, a display unit 12062, and an instrument panel 12063 are illustrated as the output device. The display unit 12062 may include, for example, at least one of an on-board display and a head-up display.

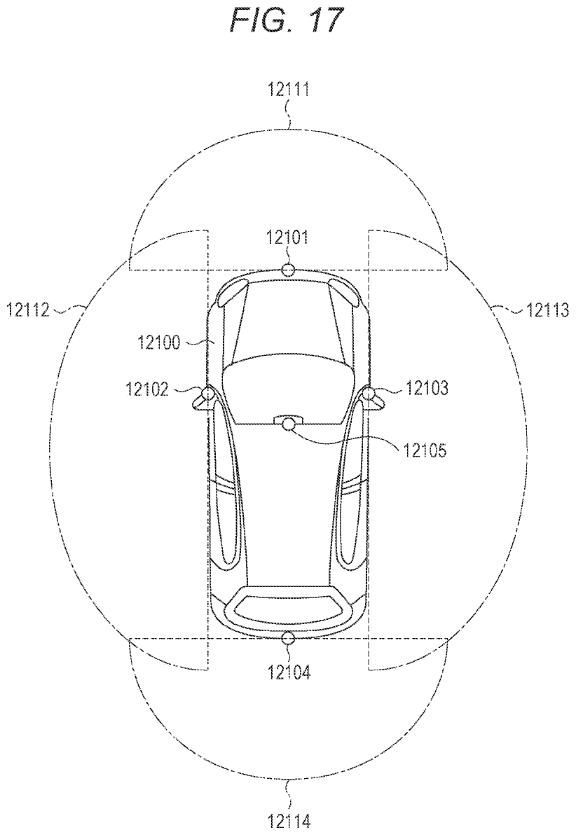

FIG. 17 is a diagram illustrating an example of an installation position of the imaging unit 12031.

In FIG. 17, the vehicle 12100 includes imaging units 12101, 12102, 12103, 12104, and 12105 as the imaging unit 12031.

The imaging units 12101, 12102, 12103, 12104, and 12105 are provided, for example, at positions such as a front nose, side mirrors, a rear bumper, a back door, and an upper portion of a windshield in the vehicle interior of the vehicle 12100. The imaging unit 12101 provided at the front nose and the imaging unit 12105 provided at the upper portion of the windshield in the vehicle interior mainly acquire images in front of the vehicle 12100. The imaging units 12102 and 12103 provided at the side mirrors mainly acquire images of the sides of the vehicle 12100. The imaging unit 12104 provided on the rear bumper or the back door mainly acquires an image behind the vehicle 12100. The front images acquired by the imaging units 12101 and 12105 are mainly used for detecting a preceding vehicle, a pedestrian, an obstacle, a traffic light, a traffic sign, a lane, and the like.

Note that FIG. 17 illustrates an example of imaging ranges of the imaging units 12101 to 12104. An imaging range 12111 indicates an imaging range of the imaging unit 12101 provided at the front nose, imaging ranges 12112 and 12113 indicate imaging ranges of the imaging units 12102 and 12103 provided at the side mirrors, respectively, and an imaging range 12114 indicates an imaging range of the imaging unit 12104 provided at the rear bumper or the back door. For example, by superimposing image data captured by the imaging units 12101 to 12104, an overhead view image of the vehicle 12100 viewed from above is obtained.

At least one of the imaging units 12101 to 12104 may have a function of acquiring distance information. For example, at least one of the imaging units 12101 to 12104 may be a stereo camera including a plurality of imaging elements, or may be an imaging element having pixels for phase difference detection.

For example, by obtaining a distance to each three-dimensional object in the imaging ranges 12111 to 12114 and a temporal change of the distance (relative speed with respect to the vehicle 12100) on the basis of the distance information obtained from the imaging units 12101 to 12104, the microcomputer 12051 can extract, as a preceding vehicle, a three-dimensional object, in particular, the closest three-dimensional object on a traveling path of the vehicle 12100 traveling at a predetermined speed (for example, 0 km/h or more) in substantially the same direction as the vehicle 12100. Furthermore, the microcomputer 12051 can set an inter-vehicle distance to be secured in advance in front of the preceding vehicle, and can perform automatic brake control (including follow-up stop control), automatic acceleration control (including follow-up start control), and the like. As described above, it is possible to perform the cooperative control for the purpose of automatic driving and the like in which the vehicle autonomously travels without depending on the operation of the driver.

For example, on the basis of the distance information obtained from the imaging units 12101 to 12104, the microcomputer 12051 can classify three-dimensional object data regarding three-dimensional objects into two-wheeled vehicles, ordinary vehicles, large vehicles, pedestrians, and other three-dimensional objects such as utility poles, extract the three-dimensional object data, and use the three-dimensional object data for automatic avoidance of obstacles. For example, the microcomputer 12051 identifies obstacles around the vehicle 12100 as obstacles that can be visually recognized and obstacles that are difficult to be visually recognized by the driver of the vehicle 12100. Then, the microcomputer 12051 determines a collision risk indicating a risk of collision with each obstacle, and if the collision risk is a set value or more and there is a possibility of collision, the microcomputer can perform driving assistance for collision avoidance by outputting an alarm to the driver through the audio speaker 12061 or the display unit 12062, or performing forced deceleration or avoidance steering through the drive system control unit 12010.

At least one of the imaging units 12101 to 12104 may be an infrared camera that detects infrared rays. For example, the microcomputer 12051 can recognize a pedestrian by determining whether or not a pedestrian is present in the captured images of the imaging units 12101 to 12104. The pedestrian recognition as such is performed by, for example, a procedure of extracting feature points in the captured images of the imaging units 12101 to 12104 as infrared cameras, and a procedure of performing pattern matching processing on a series of feature points indicating an outline of an object to determine whether or not the object is a pedestrian. If the microcomputer 12051 determines that a pedestrian is present in the captured images of the imaging units 12101 to 12104 and recognizes the pedestrian, the audio image output unit 12052 causes the display unit 12062 to superimpose and display a square contour line for emphasis on the recognized pedestrian. Furthermore, the audio image output unit 12052 may cause the display unit 12062 to display an icon and the like indicating a pedestrian at a desired position.

An example of the vehicle control system to which the technology according to the present disclosure can be applied has been described above. The technology according to the present disclosure can be applied to the imaging unit 12031 and the like among the configurations described above. Specifically, for example, the distance measuring system 11 in FIG. 1 can be applied to the imaging unit 12031. The imaging unit 12031 is, for example, light detection and ranging (LIDAR) and is used for detecting an object around the vehicle 12100 and a distance to the object. By applying the technology according to the present disclosure to the imaging unit 12031, detection accuracy of an object around the vehicle 12100 and a distance to the object is improved. As a result, for example, a vehicle collision warning can be performed at an appropriate timing, and a traffic accident can be prevented.

Note that, in the present description, a system means a set of a plurality of constituents (devices, modules (components), etc.), and it does not matter whether or not all the constituents are in the same housing. Therefore, a plurality of devices accommodated in separate housings and connected via a network and one device in which a plurality of modules is accommodated in one housing are both systems.

Furthermore, the embodiments of the present technology are not limited to the above-described embodiments, and various modifications can be made without departing from the gist of the present technology.

Note that the effects described in the present description are merely examples and are not limited, and effects other than those described in the present description may be provided.

Note that the present technology can have the following configurations.

(1)

A light receiving device including:

a measuring unit that measures time information from a light emission timing of a light source to a light reception timing at which a light receiving element receives light; a storage unit that stores a plurality of pieces of the time information;

a merge circuit that merges the same pieces of the time information measured by the measuring unit into one piece of time information; and

a histogram generating circuit that generates a histogram on the basis of one or more types of the time information after merging.

(2)

The light receiving device according to (1),

in which the merge circuit merges the same pieces of the time information included in the plurality of the time information stored in the storage unit into one piece of time information, and outputs the time information to the histogram generating circuit.

(3)

The light receiving device according to (1) or (2),

in which the merge circuit collectively outputs a plurality of types of the time information after the merging to the histogram generating circuit at one time.

(4)

The light receiving device according to any one of (1) to (3),

in which the merge circuit includes an OR cell column in which a plurality of OR circuits is arranged.

(5)

The light receiving device according to any one of (1) to (4),

in which the storage unit includes a first storage area and a second storage area, and

the light receiving device simultaneously executes storing the time information input from the measuring unit in the first storage area and outputting one or more types of the time information stored in the second storage area to the merge circuit.

(6)

The light receiving device according to any one of (1) to (3),

in which the merge circuit determines whether the time information input from the measuring unit is stored in the storage unit, and stores the time information input from the measuring unit in the storage unit in a case where the time information is not stored in the storage unit.

(7)

The light receiving device according to any one of (1) to (3), or (6),

in which the merge circuit includes:

a comparator that compares the time information input from the measuring unit with the time information stored in the storage unit; and

a selection unit that selects the time information input from the measuring unit and outputs the time information to the storage unit.

(8)

The light receiving device according to any one of (1) to (7), including

one chip having a laminated structure of two or three substrates.

(9)

A histogram generating method including:

a light receiving device measuring and storing time information from a light emission timing of a light source to a light reception timing at which a light receiving element receives light;

the light receiving device merging the same pieces of the time information that are measured into one piece of time information; and

the light receiving device generating a histogram on the basis of one or more types of the time information after merging.

(10)

A distance measuring system including:

a lighting device including a light source that emits irradiation light; and

a light receiving device that receives reflected light of the irradiation light,

in which the light receiving device includes:

a measuring unit that measures time information from a light emission timing of the light source to a light reception timing at which a light receiving element of the light receiving device receives light;

a storage unit that stores a plurality of pieces of the time information;

a merge circuit that merges the same pieces of the time information measured by the measuring unit into one piece of time information; and

a histogram generating circuit that generates a histogram on the basis of one or more types of the time information after merging.

### REFERENCE SIGNS LIST

11 Distance measuring system
21 Lighting device
22 Imaging device
31 Lighting control unit
32 Light source
41 Imaging unit
42 Control unit
52 Light receiving device
71 Pixel driving unit
72 Pixel array
73 MUX
74 Time measuring unit
75 Signal processing unit
76 Input/output unit
81 Pixel
91 TDC
101 SPAD
121 Histogram pre-stage circuit
122 Histogram generating circuit
131 Storage unit
132 Decoder
133 Merge circuit
151 Histogram holding circuit
171, 172 Selector
173 Control unit
181 Merge circuit
182 Selector
183 Comparator
191A First substrate
191B Second substrate
192A First substrate
192B Second substrate
193C Third substrate

1. A light receiving device comprising:
a measuring unit that measures time information from a light emission timing of a light source to a light reception timing at which a light receiving element receives light;
a storage unit that stores a plurality of pieces of the time information; and
a merge circuit that merges same pieces of the time information measured by the measuring unit into one piece of time information, and
a histogram generating circuit that generates a histogram on a basis of one or more types of the time information after merging.

2. The light receiving device according to claim 1,
wherein the merge circuit merges same pieces of the time information included in the plurality of the time information stored in the storage unit into one piece of time information, and outputs the time information to the histogram generating circuit.

3. The light receiving device according to claim 1,
wherein the merge circuit collectively outputs a plurality of types of the time information after the merging to the histogram generating circuit at one time.

4. The light receiving device according to claim 1,
wherein the merge circuit includes an OR cell column in which a plurality of OR circuits is arranged.

5. The light receiving device according to claim 1,
wherein the storage unit includes a first storage area and a second storage area, and
the light receiving device simultaneously executes storing the time information input from the measuring unit in the first storage area and outputting one or more types of the time information stored in the second storage area to the merge circuit.

6. The light receiving device according to claim 1,
wherein the merge circuit determines whether the time information input from the measuring unit is stored in the storage unit, and stores the time information input from the measuring unit in the storage unit in a case where the time information is not stored in the storage unit.

7. The light receiving device according to claim 1,
wherein the merge circuit includes:
a comparator that compares the time information input from the measuring unit with the time information stored in the storage unit; and
a selection unit that selects the time information input from the measuring unit and outputs the time information to the storage unit.

8. The light receiving device according to claim 1, including
one chip having a laminated structure of two or three substrates.

9. A histogram generating method comprising:
a light receiving device measuring and storing time information from a light emission timing of a light source to a light reception timing at which a light receiving element receives light;
the light receiving device merging same pieces of the time information that are measured into one piece of time information; and
the light receiving device generating a histogram on a basis of one or more types of the time information after merging.

10. A distance measuring system comprising:
a lighting device including a light source that emits irradiation light; and
a light receiving device that receives reflected light of the irradiation light,
wherein the light receiving device includes:
a measuring unit that measures time information from a light emission timing of the light source to a light reception timing at which a light receiving element of the light receiving device receives light;
a storage unit that stores a plurality of pieces of the time information;
a merge circuit that merges same pieces of the time information measured by the measuring unit into one piece of time information; and
a histogram generating circuit that generates a histogram on a basis of one or more types of the time information after merging.
